(19) United States
(12) Patent Application Publication
(10) Pub. No.: US 2024/0238147 A1
(43) Pub. Date: Jul. 18, 2024

(54) METHOD FOR DETERMINING THE TORQUE TO BE DELIVERED BY THE MOTORISED JOINTS OF A LOWER LIMB EXOSKELETON DURING WALKING OF A SUBJECT WITH LOCOMOTOR DEFICITS

(71) Applicants: FONDAZIONE ISTITUTO ITALIANO DI TECNOLOGIA, Genova (GE) (IT); I.N.A.I.L. ISTITUTO NAZIONALE PER L'ASSICURAZIONE CONTRO GLI INFORTUNI SUL LAVORO, Roma (RM) (IT); FONDAZIONE DON CARLO GNOCCHI ONLUS, Milano (MI) (IT)

(72) Inventors: Wiebke HINTERLANG, Genova (GE) (IT); Stefano MALUDROTTU, Genova (GE) (IT); Christian VASSALLO, Genova (GE) (IT); Silvia SCARPETTA, Genova (GE) (IT); Matteo LAFFRANCHI, Genova (GE) (IT); Michela CHIAPPALONE, Genova (GE) (IT); Lorenzo DE MICHIELI, Genova (GE) (IT); Maurizio FERRARIN, Milano (MI) (IT); Tiziana LENCIONI, Milano (MI) (IT); Johanna JONSDOTTIR, Milano (MI) (IT)

(21) Appl. No.: 18/564,529

(22) PCT Filed: May 27, 2022
(86) PCT No.: PCT/IB2022/054993

§ 371 Date: Nov. 27, 2023

(30) Foreign Application Priority Data
May 27, 2021 (IT) 102021000013919

(51) Int. Cl. A61H 3/00; A61H 1/02

(52) U.S. Cl. CPC A61H 3/00; A61H 1/0255; A61H 2003/007; A61H 2201/0157; A61H 2201/1207; A61H 2201/165; A61H 2201/5007; A61H 2201/5064; A61H 2201/5069; A61H 2201/5079; A61H 2203/0406; A61H 2230/625

(57) ABSTRACT

A method and a system are provided for determining the torque to be delivered by the motorized joints of a lower limb exoskeleton during a walk of a subject with locomotor deficits. The method provides for setting the torque to be delivered by the motorized joints based on various phases of the walk, a step being provided for determining a state of the walk moment by moment. The determination of the state of the walk is made by detecting the distance along the sagittal plane between the two feet of the patient, so as to identify three conditions, of which a right foot condition forward, an aligned foot condition and a left foot condition forward, the motorized joints being configured to detect the distance along the sagittal plane between the two feet of the subject.

The present invention relates to a method for determining the torque to be delivered by the motorised joints of a lower limb exoskeleton during walking of a subject with locomotor deficits.

In particular, the method involves setting the torque to be delivered by the motorised joints based on the various phases of walking.

There is also a step to determine the state of the walk moment by moment.

The present invention relates in particular to a method that defines how to apply assistive torques delivered by the motorised joints of an exoskeleton during the different phases of a patient's walk, to support the latter during rehabilitation exercises.

Loss of walking ability is one of the worst consequences of neurological diseases with motor deficits such as strokes, spinal cord injuries or traumatic brain injuries, causing loss of autonomy in daily activities and a general deterioration of the quality of life.

One of the main objectives of neurorehabilitation, therefore, is the recovery of independent and safe walking, a fundamental prerequisite for the recovery of a normal life.

The most recent rehabilitation approaches focus on the development of methods that facilitate and trigger neuroplasticity, the main basis of motor recovery after neurological diseases such as stroke. It has been amply demonstrated that neuroplasticity is stimulated by intense, repetitive exercises involving specific motor tasks, which involve the patient in participating actively in movement.

Traditional rehabilitation has significant limitations in addressing these aspects, as patient manipulation may be difficult and requires the application of force by the operator, which cannot always be precisely controlled.

In addition, it is difficult to treat subjects effectively with partial motor impairment of the lower limbs/hemiplegia, who often have several problems and gait abnormalities involving different parts of the limb.

In this scenario, exoskeletons can be a valuable tool to intensify training and rehabilitation, allowing the patient to walk independently, for longer periods of time and following correct trajectories. In this way, physiotherapists are relieved of the demanding manual intervention.

To maximise the neuro-rehabilitative effect, however, it is important that the patient remain actively involved in the voluntary execution of the movement and that this movement is not completely governed by the exoskeleton.

Thus, the need arises to develop software control strategies of the exoskeleton, and in particular of the motorised joints, that provide assistance with walking without setting the gait pattern, leaving the patient free to carry out the movements he or she desires, but simply helping him or her in the execution of such movements.

There are several exoskeletons on the market that plan to develop assistive control strategies with different approaches, methods and results.

From this point of view, it is crucial to identify precisely the phases of walking in order to provide the necessary assistance for the rehabilitative exercise.

Some of the systems and methods known to the state of the art use information from force sensors in special sensorised insoles provided in combination with exoskeletons to determine the foot's stance and detachment from the ground.

However, not all exoskeletons have sensorised soles, meaning that such systems and methods are not adaptable to all types of exoskeleton.

Some methods known to the state of the art envisage using limb acceleration sensing, measured through special accelerometers, to provide assistance through the delivery of torque by the motorised joints.

Generally, the assistance relates to hip and knee flexion during pre-swing of the legs, extension assistance in the terminal swing and locking of the knee joint during the stance phase.

Other methods include providing hip and knee flexion assistance at the beginning of the swing phase and knee extension assistance in the middle of the swing phase in the form of torque pulses of configurable amplitude and duration. These systems also provide assistance in knee extension during the stance phase by means of a virtual spring-damper system.

Furthermore, the systems known in the art generally provide for no assistance to the swinging leg, applying a control so that the presence of the joints has no effect, neither assisting nor impeding the patient's walking.

In known state-of-the-art systems, assistive torques are provided after the detected change of state, i.e. of walking phase, in the form of pulses of a given duration.

Once the pulse is complete, assistance is no longer provided, regardless of the patient's status, even though the patient may not yet have completed the movement, causing the patient to react in an inappropriate manner.

There is therefore a need, not met by the methods known to the state of the art, to obtain correct and effective identification of the various phases of walking, without the use of specific sensor systems, such as accelerometers, gyroscopes, or the like.

The present invention achieves the above-mentioned purposes by realising a method, as described above, in which the determination of gait status is performed by measuring the distance in relation to the sagittal plane between the patient's two feet, so that three conditions are identified, namely a right foot forward condition, an aligned foot condition and a left foot forward condition.

As will be evident from the illustration of some exemplary embodiments and the subsequent disclosure, the distance between the user's feet is identified on the basis of a projection of the position of the feet on the sagittal axis, so as to identify a foot in a forward position (the forward foot), a foot in a backward position (the rear foot), or the feet in an aligned position.

Advantageously, the motorised joints of the exoskeleton are configured to detect the distance, along the sagittal plane, between the subject's two feet.

One of the most advantageous aspects of the method that is the object of the present invention is the use of a single parameter for the identification of the phase of walking, i.e. the distance between the feet with respect to the sagittal plane, to identify three states of walking.

This provides a simple approach to analysing the walk, but one that is sufficient to describe the walk comprehensively and assess the correct assistive torque to be delivered by the motorised joints.

Since only one parameter is used to identify the three aforementioned walking states, one of the main advantages of the strategy described is that no incorrect detection, i.e. wrong identification of the walking phase, can occur.

Another advantage is that the method does not require any additional sensor in addition to the angle encoders, already present in the joints. This greatly simplifies the control scheme and reduces the hardware complexity of the exoskeleton.

Preferably, like exoskeletons known in the state of the art, the exoskeleton used for performing the method that is the object of the present invention comprises four motorised joints, two of which are located at the subject's knees and two of which are located at the subject's hips, which motorised joints are connected to each other via two femoral segments and two tibial segments.

Pursuant to this configuration, according to a preferred embodiment, the distance between the feet of the subject is calculated on the basis of the detection of the angles of the knees and the hip along the sagittal plane, detected by the motorised joints, and on the basis of the length of the tibial and femoral segments.

According to a possible embodiment, there is a step of setting a threshold distance between the feet, identifying the condition of aligned feet.

This variant makes it possible to adapt the method that is the object of the present invention not only to patients, but also to therapists and to the different motor tasks to be executed during rehabilitation.

Based on clinical studies, it has been observed that, in healthy subjects, this threshold value is about 10 cm, that is, if the feet are placed at a distance less than or equal to 10 cm from each other, they are considered to be side by side.

Preferably, the threshold distance is set through a human-machine interface connected to the exoskeleton.

According to a first embodiment, the transition from one of said conditions to the other exhibits hysteresis behaviour.

This feature, in combination with the simplicity of the method's execution and the limited number of states to be detected, makes it possible to avoid too many changes when the user's feet are at a distance corresponding to the threshold distance value.

According to a preferred embodiment, there is a step of identifying the supporting leg and the swinging leg.

In combination with this step, there is a step of setting a transition time, corresponding to the period required for a leg to move from supporting leg to swinging leg and vice versa.

Unlike the methods known in the art, the method that is the object of the present invention does not provide for detecting the moment when the foot comes into contact with the ground, i.e. the moment when one of the two legs becomes the supporting leg, but provides for detecting when one foot is in a position more advanced than a certain distance, greater than the threshold distance, with respect to the other foot.

It is possible to assume that the contact of the foot with the ground occurs shortly after the change of condition, from aligned feet to right/left foot forward.

For this reason, the method that is the object of the present invention provides for the introduction of the transition time parameter, adapted to indicate the time taken by the user to shift weight from one leg to the other.

Advantageously, this time is configurable, based on the walking speed of the user.

Once this transition time has elapsed, it is possible to assume that the foot that is in a retracted position is relative to the leg freed from the user's body weight, which is about to make the step, i.e. the swinging leg.

It is therefore evident that the method that is the object of the present invention does not require any specific triggering movement by the user in order to perform the gait analysis.

As mentioned above, one of the most advantageous aspects of the method that is the object of the present invention is the possibility of identifying the various stages of walking using a sole parameter.

On the basis of this identification, command signals are sent to control the motorised joints, so that certain assistive torques can be delivered.

Due to the identification of the various walking phases, the torques delivered will be different for each joint, as the aid must be differentiated according to the function performed by the limb during walking.

In particular, the method covered by the present invention relates to a lower limb exoskeleton comprising four motorised joints, two of which are joints placed at the patient's knees and two at the patient's hips.

Thus, each joint provides a contribution, i.e. a torque for assisting the patient's walk, different for each phase of the walk.

These contributions can be provided individually or in combination, i.e. it is possible to activate a single joint to deliver a specific torque, or activate two or more joints together.

As will be disclosed, a single joint can deliver an assistive torque based on more than one contribution, such as the hip joint, which is responsible for extending/flexing the hip to perform walking, but also for maintaining the patient's torso in an upright condition.

Each assistive torque provided, which will be disclosed in detail, is the result of a thorough understanding of the main difficulties encountered by post-stroke patients during walking, carried out in collaboration with clinical partners.

In particular, the most frequent difficulties during walking faced by post-stroke patients are:
instability on the plegic limb during support,
excessive anterior inclination of the trunk, which causes incorrect patient posture,
insufficient distance of the foot from the ground during the swing phase,
inadequate control of the plegic hip joint,
contracture of the plegic hip flexor muscles,
generally impaired coordination and proprioception,
difficulty in extending the hip joint and making correct progression,
difficulty in flexing the swinging limb and detaching the foot from the contact with the ground during stride execution.

These problems are addressed by providing specific assistance throughout the entire walking cycle, preferably in the form of a single assistive torque, obtained from the sum of different contributions provided by the joints, in particular:
knee extension of the supporting leg;
hip extension of the supporting leg;
hip flexion of the swinging leg,
knee flexion of the swinging leg.

As mentioned above, these contributions may be provided individually or in combination.

It follows that, for each phase of the walk, the plegic limb joint can rely on configurable amounts of assistive torques, which help to follow the physiological kinematics of the joint during gait, i.e. extension during the stance and flexion phase during the swing phase.

Finally, the ability to provide assistive torques continuously throughout the entire cycle of the walk makes it possible to provide proper assistance to patients, making walking safer, even in the case of possible changes in trajectory during the different steps.

It is evident from what has just been disclosed, how the method that is the object of the present invention is based on the main clinical aspects relating to the rehabilitation of the gait in subjects with motor impairment of the lower limbs.

Indeed, the method that is the object of the present invention provides assistance only during phases of reduced ambulation, solely to the joints that need assistance, and in adjustable quantities, depending on the patient's specific clinical condition.

Despite the assistance provided, the method allows and facilitates voluntary movements of the patient, compensating both friction and inertia of the motorised joints and the weight of the limbs.

These and other features and advantages of the present invention will become clearer from the following disclosure of some embodiments illustrated, by way of example only, in the attached drawings, wherein:

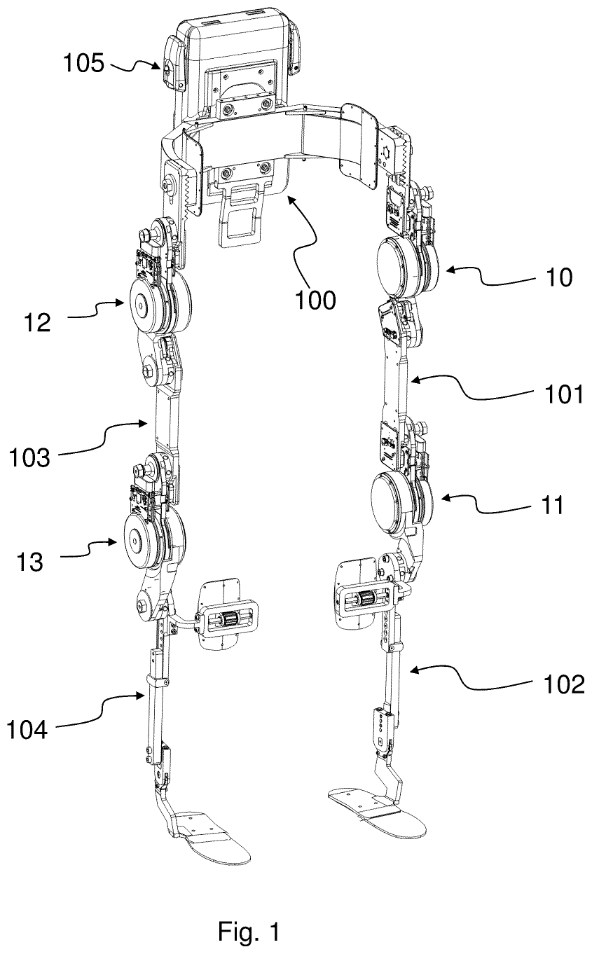

FIG. 1 illustrates a possible embodiment of the exoskeleton used to perform the method that is the object of the present invention;

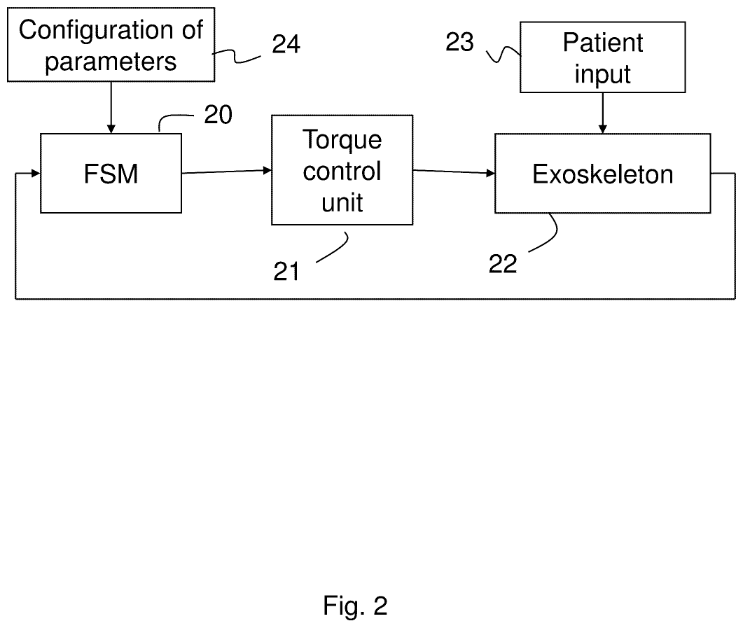

FIG. 2 shows an illustrative diagram of how the method that is the object of the present invention works;

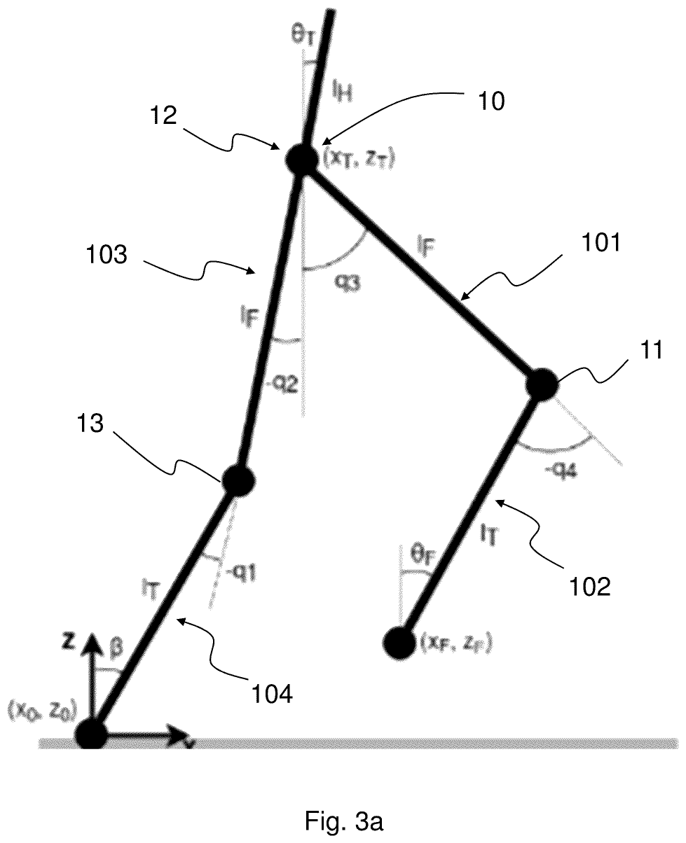

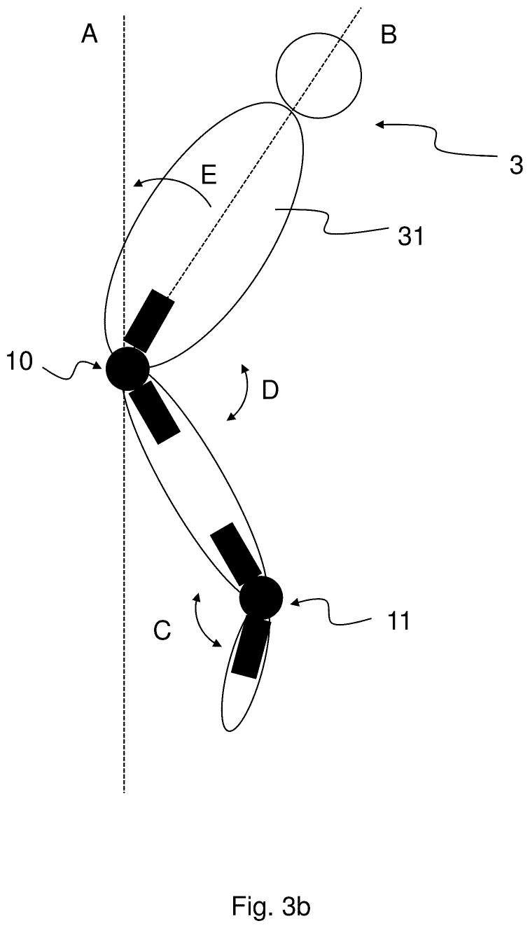

FIGS. 3a and 3b illustrate two stylisations of a patient, in order, respectively, to describe a possible methodology for detecting the distance between the feet of the patient and to identify the various torques delivered by the joints of the exoskeleton;

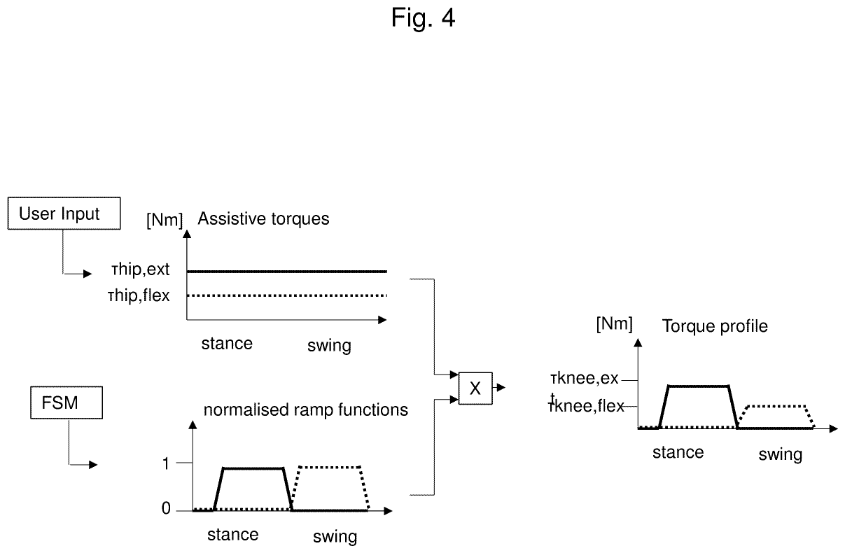

FIGS. 4 to 6 illustrate graphs relating to the profiles of the torques delivered by the different motorised joints, depending on the phase of the walk.

It should be noted that the Figures appended to this patent application illustrate only some possible forms of the method for determining the torque to be delivered by the motorised joints of an exoskeleton that is the object of the present invention, in order to better understand the advantages and features described.

Such embodiments are therefore intended purely for illustrative purposes and not as a limitation to the inventive concept of the present invention, i.e. that of realising an innovative method that enables the precise and effective identification of the phases of a patient's walk, through the detection of a single parameter, in order to determine the torque to be delivered to the motorised joints of the exoskeleton to facilitate walking and allow the recovery of muscles and joints, through rehabilitation exercises in which the patient actively participates.

With particular reference to FIG. 1, a possible embodiment of the exoskeleton used for performing the method that is the object of the present invention is illustrated according to one possible embodiment.

The exoskeleton illustrated in FIG. 1 refers to the movement of the lower limbs and provides a symmetrical configuration with respect to the sagittal plane of a patient.

Specifically, the exoskeleton comprises a pelvis element 100, which can be attached to a patient's pelvis, connected to two femoral segments 101, 103 and two tibial segments 102, 104.

The exoskeleton is therefore made up of a series of levers, segments 101, 102, 103 and 104, which have a relative movement between them, adapted to mimic the movements of a user's leg, which movement is ensured by the activation of joints 10, 11, 12 and 13 that allow the levers to rotate one with respect to the other.

The pelvis segment 100 further supports a central processing unit and an electricity power unit.

In the specific case of FIG. 1, the central processing unit and the power supply unit are inserted within a single device 105, fixed to the pelvis segment 100.

The device 105 is therefore responsible for the generation of the control signals for activating the frame of the exoskeleton, as well as distributing the electricity necessary for operating the electric motors provided in the joints 10, 11, 12 and 13 and positioned at the joints of the patient.

The joints 10, 11, 12 and 13 comprise sensors adapted to detect the operating conditions of the joints themselves and the positioning of the various segments 101, 102, 103 and 104 of the exoskeleton frame.

All data and power are transmitted along the exoskeleton by means of connection cables, not illustrated in the Figures, starting from the device 105 and connect to the motorised joints via segments 101, 102, 103 and 104.

According to the variant illustrated in the Figure, the ankle part, i.e. the connecting zone between segment 102 and 104 and the foot, consists of a passive joint, which does not need connections either for power or for data transmission.

The motorised joints 10, 11, 12 and 13 therefore do not simply perform a function relating to the movement of the segments, but guarantee a functional connection, both mechanical and electrical, between the various components of the exoskeleton.

As mentioned above, the information detected by the motorised joints is processed by the device 105, which, preferably, is responsible for generating different control signals for each joint, so as to set the joints themselves to deliver a given torque.

FIG. 2 shows a concept diagram of a possible image processed by the method that is the object of the present invention.

The phases of the patient's walk are in fact managed at a higher level by a finite-state machine (FSM) 20, which generates the signals to set the motorised joints to deliver a given assistive torque.

In particular, the FSM 20 changes the states based on a detection of a change in the patient's walk cycle.

In fact, the FSM 20 receives as input the phases of the walk, detected by a state classifier performed continuously in the background during the walk, configured to monitor the kinematic positioning of the exoskeleton.

The FSM 20 therefore then the control signals relating to the setting of the torque to be delivered to the different joints to a torque control unit 21, which in turn acts on the exoskeleton 22.

The kinematic configuration of the exoskeleton, which is returned to the FSM 20, is obviously influenced by the contribution of the patient 23, who can perform free movements, which are aided by the torques delivered by the various mechanical joints.

As will be disclosed later, the method provides for the detection of one or more parameters 24, which are configurable and which modify the execution of the method that is the object of the present invention.

As described above, the method that is the object of the present invention provides for identifying the steps of walking based on the distance between the feet along the sagittal axis of a patient.

In particular, this distance is detected thanks to the presence of the angular encoders present in the motorised joints 10, 11, 12 and 13.

FIG. 3a aims to describe how the distance between the feet of a patient occurs, which is illustrated in FIG. 3a in stylised form, in particular through the projection on the sagittal plane of the motorised joints 10, 11, 12 and 13 and of the tibial and femoral segments 101, 102, 103 and 104.

Precisely because it is a projection on the sagittal plane, the motorised joints 10 and 12 positioned at the two joints of the patient's hip are superimposed in FIG. 3a.

The peculiar positioning of the motorised joints 10, 11, 12 and 13 allows for four position sensors, i.e. angular encoders, integrated within joints 10-13 and located at the patient's two hips and knees. These position sensors are configured to measure the angles shown in FIG. 3a with the references q1, q2, q3 and q4, relating, respectively, to the angle of the left knee, left hip, right hip and right knee.

From these angles, which are relative measurements referring to the individual elements of the exoskeleton, together with information on the lengths of the exoskeleton segments of femur 101, 103 and tibia 102, 104, in the image denoted 1F and 1T respectively, it is possible to reconstruct the overall posture of the exoskeleton in space and thus estimate the distance in the sagittal plane, corresponding to the X axis in FIG. 3a, between the rearmost foot (denoted as x0) and that of the foremost foot (denoted as xF).

The relationships that allow the distance between the feet to be obtained, according to the notation shown in the Figure, are as follows:

$$x T = 1 T * sin ( + 1 F * sin ( beta + q 1 )$$

$$zT = 1 T * cos ( + 1 F * cos ( beta + q 1 )$$

$$thetaT = + q 1 + q 2$$

$$xF = xT - ( 1 F * sin ( thetaT - q 3 ) + 1 T * sin ( thetaT - q 3 - q 4 ) )$$

$$zF = z T - ( 1 F * cos ( thetaT - q 3 ) + 1 T * cos ( thetaT - q 3 - q 4 ) )$$

FIG. 3b illustrates a basic scheme of possible torques acting on the patient 3.

Patient 3 has the exoskeleton of FIG. 1, then two hip joints 10, 12 (of which only number 10 is illustrated in FIG. 3b) and two knee joints 11, 13 (of which only number 11 is illustrated in FIG. 3b) and has a trunk 31, with a corresponding longitudinal axis B.

FIG. 3b is also shown in order to illustrate the possible movements that the joints 10-13 cause the patient's limbs to perform.

Specifically, joint 10 allows for an extension/flexion of the hip joint according to the direction indicated by arrow D and a swing of the torso 31 according to the directions of arrow E.

Joint 11, on the other hand, allows extension/flexion of the knee joint in the directions indicated by arrow C.

The torques that are delivered by the different joints 10-13 are diversified for each joint and are established according to the phases of the walk.

In order to identify the stages of walking, the method that is the object of the present invention involves first measuring the distance between the feet along the sagittal plane.

Depending on the distance, it is possible to detect three phases of the walk, in particular right foot forward, left foot forward and aligned feet.

Based on this survey, it is possible to identify the supporting leg and the swinging leg.

For example, moving from the condition of aligned feet to the condition of right foot forward, it is possible to assume that the right leg becomes the supporting leg shortly after the change of state between “aligned feet” and “right foot forward” has occurred.

This hypothesis is reinforced by determining the transition time, i.e. the time between the change of state of a leg from swinging to supporting leg.

Depending on the condition of the swinging leg or supporting leg, the torques delivered by the motorised joints vary.

With regard to the supporting leg, there are three main components that can be configured to act separately or simultaneously, depending on the patient's needs.

A first component is the assistive torques intended to maintain the extension of the knee.

This torque is proportional to the knee flexion angle and is calculated by a proportional-derivative controller (PD) using the formula τknee,ext=pknee×φknee+dknee×ωknee, wherein
φknee is the knee angle, equal to zero if the knee is fully extended,
ωknee is the angular speed of the knee detected at each instant,
pknee and dknee are respectively a multiplicative parameter and a parameter to dampen any swings.

A virtual elastic damper system is created at the knee joint.

The second contribution is given by an assistive torque adapted to aid hip extension.

Unlike the torque at the knee, this torque is not proportional, but, as will be disclosed later, can be considered constant.

Preferably said assistive torque is applied with a delay, based on the transition time, i.e. it is applied during the period between the state of aligned feet and right/left foot forward.

Obviously in the case of right foot forward, the torque will be delivered from the right hip joint, while in the case of left foot forward, the torque will be delivered from the left hip joint, respectively joints 12 and 10, with reference to FIG. 1.

The third contribution is also provided by the motorised joint at the patient's hips and is a torque proportional to the tilt angle of the patient's torso 31, i.e. the angle between the longitudinal axis B of the torso 31 and the frontal plane A.

This helps the patient to maintain an upright position, according to the direction indicated by arrow E.

Preferably the tilt angle of the trunk 31 is detected by device 105 positioned at the level of the patient's pelvis 3.

Again, the amount of torque to be delivered is calculated by a PD controller on the basis of the trunk tilt angle 31 (τtrunk=phip×φIMU+dhip×ωIMU), wherein
φIMU is the angle that measures the forward unbalance (the tilt) of the torso, which is zero if the torso is fully erect, i.e. vertical, and is measured by an inertial sensor placed on the pelvis of the exoskeleton,
ωIMU is the speed relative to the movement of the torso,
phip indicates a torque proportional to the relative angle of the trunk relative to the vertical,
dhip is a parameter for damping any swings.

A range of values can be provided around the zero value of the tilt angle, where no assistive torque is delivered.

Regarding the swinging leg, there are two contributions that can act separately or simultaneously, according to the needs of the patient.

The first contribution is related to an assistive torque aimed at ensuring hip flexion, which can be considered constant.

This torque is applied during the initial phase and the intermediate phase of leg swing and partially also during the terminal part.

The second contribution is an assistive torque adapted to allow constant knee flexion, which is applied mainly during the initial phase of leg swing, to facilitate the detachment of the foot from the ground.

The method that is the object of the present invention also involves changing the values of hip and knee flexion torques by applying compensation relative to the weight of the swinging leg.

Based on all the contributions disclosed, the method that is the object of the present invention makes it possible to generate various assistive torque profiles to be applied to the patient's lower limbs, which are described and illustrated in FIGS. 4, 5 and 6.

In particular, FIG. 4 illustrates the calculation of the profile, i.e. the trend of the values of the assistive torque.

These profiles are obtained by multiplying the values of the assistive torques, the dashed line illustrates the torque related to hip flexion, while the solid line illustrates the torque related to hip extension, with the ramp profiles processed by the FSM, according to the phases of the walk.

According to FIG. 4, both torques are multiplied by a ramp function, so as to generate smoother transitions at the phase shifts of the walk.

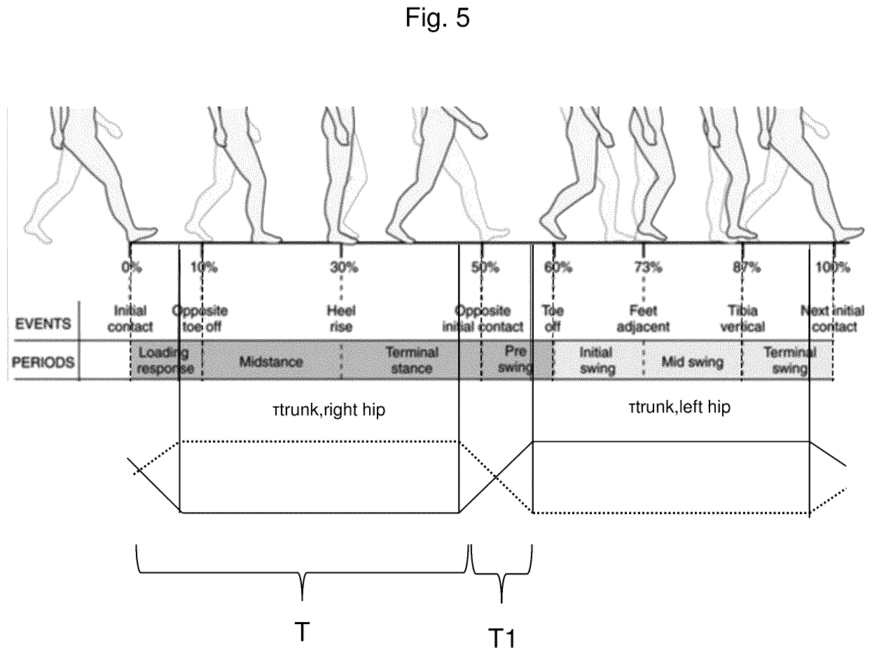

FIG. 5 illustrates the torque profile for hip extension to move the trunk along the sagittal plane.

This torque always acts on the motorised joint at the hip of the supporting leg.

In the initial part (left part) of FIG. 5, the right leg is in support and the torque is delivered by the right hip joint, indicated by the dotted line.

During a change in state, for example the passage of the left leg from swinging to supporting leg, the torque delivered by the right hip joint is not abruptly blocked, but decreases linearly, as illustrated in time T1 of FIG. 5.

At the same time T1, the torque delivered by the left hip joint, a continuous line, increases linearly and becomes constant throughout the period between the “left leg support” and “left leg swinging” state.

In this way, there is no abrupt halt in the joints and the torque controlling the trunk position is constant throughout the entire walking phase.

As mentioned above, the transition time T, shown in the Figure as the time the right (or left) leg remains in support, is a parameter that can be set and that varies mainly according to the patient's walking speed.

Unlike the time T, the time T1 represents the time necessary for the patient to shift weight from one leg to the other, which occurs when both feet are on the ground, i.e. a double stance phase.

This phase, at natural speed, is approximately 10% of the pitch cycle.

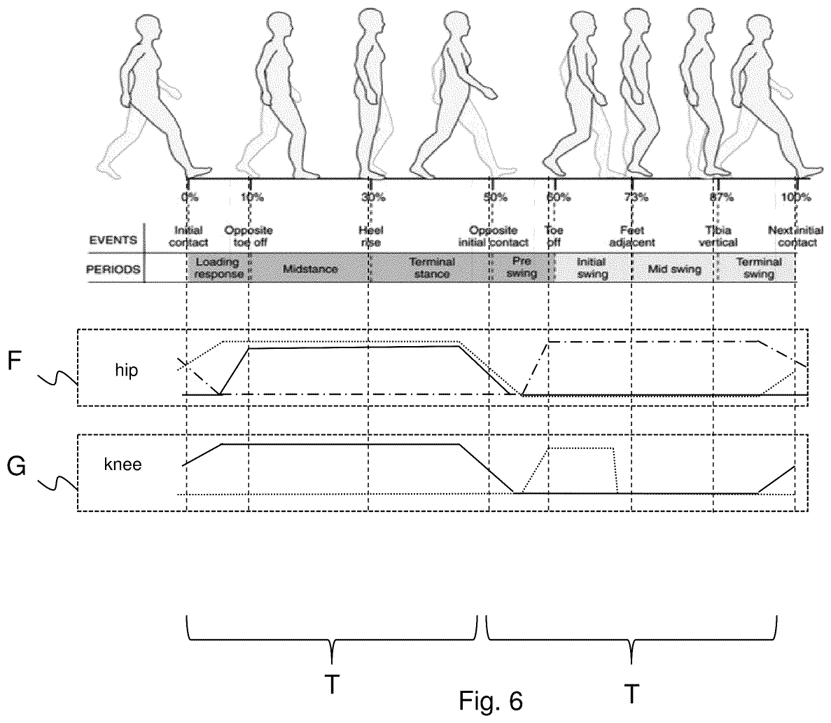

The entire walking phase is also illustrated in FIG. 6, in which the gradual transitions due to ramp functions are shown, as in FIG. 5.

In particular, FIG. 6 shows a complete cycle of walking for the right leg, in which the right leg begins as a supporting leg, becomes a swinging leg, to return to being a supporting leg at the end of the cycle.

The vertical dotted lines indicate the state changes that are detected by the FSM.

In addition, FIG. 6 illustrates the transition times T related to the changes from supporting leg to swinging leg.

The lower part of FIG. 6 illustrates the behaviour of the different torques disclosed above, in particular the torques delivered by the hip joint, box F, and the torques delivered by the knee joint, box G.

1.-11. (canceled)

12. A method for determining a torque to be delivered by motorized joints of a lower limb exoskeleton during a walk of a subject with locomotor deficits, which method provides for setting the torque to be delivered by the motorized joints based on various phases of the walk,
the method comprising a step of determining a state of the walk moment by moment,
wherein determination of the state of the walk is done by measuring a distance along the sagittal plane between the subject's two feet, so that at least three conditions are identified, including a right foot forward condition, a lined-up foot condition, and a left foot forward condition,
wherein the motorized joints are configured to detect the distance along the sagittal plane between two feet of the subject.

13. The method according to claim 12, wherein the exoskeleton comprises four motorized joints, of which two joints are configured to be placed at the knees of the subject and two joints are configured to be placed at the hips of the subject, the motorized joints being connected to each other through two femoral segments and two tibial segments, the distance between the feet of the subject being calculated based on the detection of the angles of the knees and the hips along the sagittal plane, detected by the said motorized joints and based on the length of the tibial and femoral segments.

14. The method according to claim 12, further comprising a step of setting a threshold distance between the feet of the subject that identifies the condition of aligned feet.

15. The method according to claim 12, wherein a transition from one of said conditions to the other exhibits hysteresis behavior.

16. The method according to claim 12, further comprising a step of identifying the supporting leg and the swinging leg, a step of setting a transition time, corresponding to a period required for a leg to change from supporting leg to swinging leg and vice versa.

17. The method according to claim 12, wherein the step of setting the torque to be delivered to the motorized joints provides for a diversified setting for each joint.

18. The method according to claim 17, wherein the torque setting step comprises providing torque from the knee joint of the supporting leg, aimed at knee extension, the torque being proportional to the knee flexion angle.

19. The method according to claim 17, wherein the torque setting step comprises delivering torque from the hip joint of the supporting leg aimed at hip extension, the torque being delivered in the period between the aligned foot condition and the left or right foot forward condition.

20. The method according to claim 17, wherein the torque setting step comprises providing torque from the hip joint of the supporting leg aimed at hip extension, the torque being proportional to the angle between the longitudinal axis of the subject's trunk and the frontal plane.

21. The method according to claim 17, wherein the step of setting the torque provides for the delivery of a torque by the swinging leg hip joint aimed at flexing the hip, the torque being delivered during said transition time.

22. The method according to claim 17, wherein the step of setting the torque provides for the delivery of a torque from the knee joint of the swinging leg aimed at bending the knee, the torque being delivered in the period between the condition of left or right foot forward to the condition of aligned feet.

23. A computer-readable medium having stored thereon instructions, which when executed by a processing unit, configure the processing unit to perform the method according to claim 12.

24. A computing device comprising:
a central processing unit;
a computer-readable medium having stored thereon instructions, which when executed by a processing unit, configure the processing unit to perform the method according to claim 12.

25. The computing device according to claim 24, further comprising a power supply unit.

26. An exoskeletal system comprising:
a plurality of motorized joints;
a plurality of support segments;
a central processing unit; and
a computer-readable medium having stored thereon instructions, which when executed by a processing unit, configure the processing unit to perform the method according to claim 12.

27. The exoskeletal system according to claim 26, wherein the exoskeleton comprises four motorized joints, of which two joints are configured to be placed at the knees of the subject and two joints are configured to be placed at the hips of the subject,
wherein the support segments include at least two femoral segments and two tibial segments, the motorized joints being connected to each other through the two femoral segments and the two tibial segments, the distance between the feet of the subject being calculated based on the detection of the angles of the knees and the hips along the sagittal plane, detected by the motorized joints and based on the length of the tibial and femoral segments.

28. The exoskeletal system according to claim 26, wherein the method performed by the central processing unit further comprises a step of setting a threshold distance between feet of the subject that identifies the condition of aligned feet.

29. The exoskeletal system according to claim 26, wherein a transition from one of said conditions to the other exhibits hysteresis behavior.

30. The exoskeletal system according to claim 26, wherein the method performed by the central processing unit further comprises a step of identifying the supporting leg and the swinging leg, a step of setting a transition time, corresponding to a period required for a leg to change from supporting leg to swinging leg and vice versa.

31. The exoskeletal system according to claim 26, wherein the step of setting the torque to be delivered to the motorized joints provides for a diversified setting for each joint.
